(19) United States
(12) Patent Application Publication
(10) Pub. No.: US 2012/0240393 A1
(43) Pub. Date: Sep. 27, 2012

(54) DEVICE FOR ATTACHING AND RECOGNISING AT LEAST TWO COMPONENTS

(75) Inventor: Thomas Farges, Le Mee Sur Seine (FR)

(73) Assignee: DURA AUTOMOTIVE SYSTEMS SAS, Bievres (FR)

(21) Appl. No.: 13/500,367

(22) PCT Filed: Oct. 1, 2010
(86) PCT No.: PCT/FR2010/052079

§ 371 Date: Jun. 12, 2012

(30) Foreign Application Priority Data
Oct. 7, 2009 (FR) 0956983

(51) Int. Cl. B23P 21/00

(52) U.S. Cl. 29/705

(57) ABSTRACT

The device includes at least one magnet associated with one of the components and at least one Hall-effect sensor arranged beneath a ferromagnetic part of the other component, so that the at least one magnet ensures the fixing of the components, while the at least one Hall-effect sensor provides, depending on magnet orientation, detection of the at least one magnet, through the ferromagnetic part, so as to distinguish the component equipped with the at least one magnet.

This invention relates to a device for fixing and recognising at least two components.

This invention has a particularly advantageous application, which is in no way limiting, within the automotive field, for example for fixing and recognising parts on a support.

One of the problems that this invention proposes to solve is therefore to be able to fix a part (or other component) onto a support (or other component) with, as its aim, that the support automatically recognises the part.

In order to solve this problem, different technical solutions have been proposed.

For example, the part to be fixed has recessed and protruding geometrical shapes of the stud, pin, etc. type, capable of cooperating with matching shapes on the support in combination with the sensor associated with the support. This type of fixing generally comprises a flexible part to ensure retention requiring special personnel to separate the two elements.

This solution is unsatisfactory, given that it requires the presence of specific assembly shapes with small tolerances.

The aim of the invention is to overcome these drawbacks in a simple, safe, effective and rational manner.

The problem that the invention proposes to solve is to detect the presence of a component or to distinguish between two components designed to be fitted onto the same support.

In order to solve this problem, a device has been designed and developed which comprises at least one magnet secured to one of the components and at least one Hall-effect sensor positioned beneath a ferromagnetic part of one of the components, so that the magnet or magnets ensure(s) the fixing of the components, while the said sensor or sensors may or may not detect, depending on their orientation, said magnet or magnets, through the ferromagnetic part, in order to distinguish the component fitted with the magnet or magnets.

Another problem that the invention proposes to solve is to be able to fix the components and identify them.

In order to solve such a problem, one of the components has several ferromagnetic parts and several sensors, while the other component has a combination of magnets in order to distinguish several components capable of fixing onto the same component.

Another problem that the invention proposes to solve is not to be able to fix the components. To this end, each of the components has a magnet in order to make it impossible to fix the said components if the two magnets are in opposition.

Otherwise, each of the components has a combination of magnets so as to make it impossible to fix said components if the two combinations are not identical and so as to identify the possible combination by the sensor or sensors.

As stated, the device has an advantageous application in the automotive field in order to fix and recognise a part on a support.

The invention is described below in further detail with the aid of the accompanying drawings, in which:

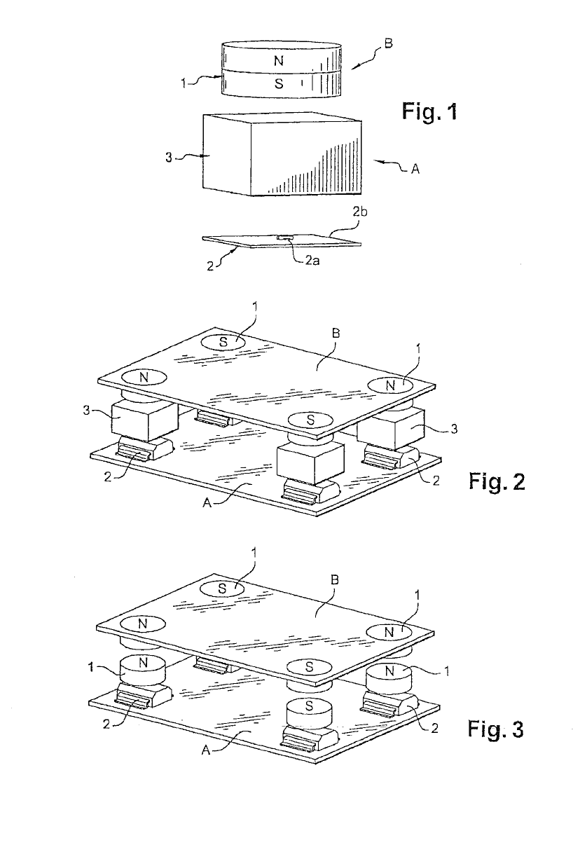

FIG. 1 is a schematic view showing the basic principle of the device according to the invention;

FIG. 2 shows an application of the device using a combination of magnets on one of the components and ferromagnetic parts on the other component with the aim of being able to distinguish several components capable of being fixed on the same component;

FIG. 3 is a view similar to that of FIG. 2, in the case of an application of the device using magnets only.

The fixing and recognising device having at least two components according to the invention, is described and illustrated in the drawings, by way of a non-limiting example, to fix a part (B) onto a support (A) having at least one ferromagnetic part (3).

The device comprises at least one magnet (1) associated with the part (B) and at least one means (2) associated with the support (A) and capable of detecting the magnet or magnets (1), through the ferromagnetic part (3), in order automatically to recognise the part (B). Advantageously, the means capable of detecting the magnet or magnets is a Hall-effect sensor (2a) mounted in combination with an electronic card (2b) where the sensor is arranged beneath the ferromagnetic part (3) of the support (A). The magnets (1) ensure the fixing of the part (B) onto the support (A), while the Hall-effect sensors (2a) ensure the detection of the said magnet or magnets (1), so as automatically to distinguish, i.e. recognise the part (B).

From this basic design, by multiplying the number of ferromagnetic parts (3) and sensors (2) on the support (A) and by binding the part (B) to a combination of magnets (1), it is possible to distinguish several parts (B) that can fix onto the same support (A). The fixing on the ferromagnetic part (3) is independent of the polarity of the magnets (1) and takes place, in the example illustrated in FIG. 2, at the four magnets. On the other hand, only the Hall-effect sensors (2) located at the North or South magnets will detect the presence of a magnet and, consequently, the part (B).

According to another embodiment, when a magnet (1) is mounted on the support (A) and another magnet on part (B), it is possible to prohibit the assembly of a part whose magnet is in opposition with that of the support (A). It is also possible to identify the presence of a part mounted on the support, when assembly is possible, due to the variation in the magnetic field.

Similarly, by using only magnets on the support (A) and on the part (B), it is possible to prohibit the assembly of certain combinations of magnets between the support and the part (B), and to identify the assembly of the part (B) whose combination of magnets is possible.

The advantages clearly emerge from the description, noting in particular:
the device is not visible;
the absence of specific shapes;
the possibility of detecting components from a distance;
the possibility of detecting components with a high tolerance;
reduced costs.

1. Fixing and recognition device having at least two components comprising at least one magnet associated with one of the components and at least one Hall-effect sensor arranged beneath a ferromagnetic part of one-another of the components, so that the at least one magnet ensure the fixing of the components and the at least one Hall-effect sensor provides, depending on magnet orientation, detection of the at least one magnet, through the ferromagnetic part, so as to distinguish the component equipped with a the at least one magnet.

2. Device according to claim 1, wherein the another of the components has several ferromagnetic parts and several sensors, and the one of the components has a combination of magnets in order to distinguish several components capable of fixing onto the same component.

3. Device according to claim 1, wherein each of the components has a magnet in order to fix the said components if the two magnets are in opposition.

4. Device according to claim 1, wherein each of the components has a combination of magnets in order to fix the said components if combinations of the components are not identical and in order to identify the combination by the at least one sensor due to a variation in magnetic field.

5. Device according claim 1, employed in the automotive field in order to fix and recognise a part on a support.
